(19) United States
(12) Patent Application Publication
(10) Pub. No.: US 2014/0227160 A1
(43) Pub. Date: Aug. 14, 2014

(54) MATERIAL AND METHOD FOR SEALING OFF CAVITIES

(71) Applicant: BASF SE, Ludwigshafen (DE)

(72) Inventors: Gerhard Olbert, Dossenheim (DE); Jochen Gauer, Ludwigshafen (DE); Robert Kuhn, Hassloch (DE); Andreas Wölfert, Bad Rappenau (DE); Holger Friedrich, Worms (DE)

(73) Assignee: BASF SE, Ludwigshafen (DE)

(21) Appl. No.: 14/180,597

(22) Filed: Feb. 14, 2014

Related U.S. Application Data
(60) Provisional application No. 61/764,555, filed on Feb. 14, 2013.

(51) Int. Cl. E04B 1/76; C01B 17/79; C01B 21/38; E04B 1/80; E04B 1/94

(52) U.S. Cl. CPC E04B 1/7604; E04B 1/803; E04B 1/942; C01B 21/38; C01B 17/79
USPC 423/392; 428/69; 156/60; 156/253; 156/294; 423/535

(57) ABSTRACT

The material proposed for sealing off cavities between structural components formed of materials having different thermal characteristics comprises an intumescent mat completely sealed in a polymeric film and the interior bounded by the polymeric film and containing the intumescent mat is evacuated.

### CROSS-REFERENCE TO RELATED APPLICATIONS

This application claims benefit (under 35 USC 119(e)) of U.S. Provisional Application Ser. No. 61/764,555, filed Feb. 14, 2013, which is incorporated herein by reference in its entirety.

### BACKGROUND OF THE INVENTION

This invention relates to a material and method for sealing off cavities.

It is frequently necessary to bridge cavities between structural components, to achieve a reliable mechanical fit between same as well as to seal off same from each other. This can be particularly problematical when the structural components are formed of materials having mutually different properties, especially having different thermal characteristics. For example, the thermal characteristics of ceramic materials are extremely different from those of metallic materials. The thermal characteristics of a material, i.e., its dimensional response to temperature changes, are typically described in terms of the thermal expansion coefficient.

The problem of sealing off structural components made of ceramic materials from structural components made of metallic materials arises in high-temperature reactors for example. Reactors of this type frequently contain catalyst beds in metallic cages, which have to be sealed off from a load-bearing component, especially the reactor wall. High-temperature reactors frequently also contain ceramic internals, such as monoliths. Reactor cross sections can be round or polygonal. Monoliths as well as caged catalyst beds have to be sealed off with regard to the reactor wall.

Intumescent mats, i.e., sheetlike plies, have proved advantageous here because they expand (swell up) in the event of temperature elevations. Intumescent mats are generally composed of silicates, e.g., aluminum silicate, an expandable mica, e.g., vermiculite, and an organic binder.

INTERAM® intumescent mats are available from 3M for example.

However, the increase in volume of known intumescent mats due to temperature elevation in the specific area of interest frequently leads to inadequate sealing only. More particularly, it is on its own insufficient to provide the requisite bracing force.

It is an object of the present invention to provide a material that is suitable for sealing off cavities between structural components, even those made of materials having extremely different thermal characteristics, in a reliable manner and for ensuring a reliable mechanical fit, that does not have the above disadvantages and that makes it possible to install or assemble structural components in a simple manner with a reliable fit and without bracing.

### BRIEF SUMMARY OF THE INVENTION

It has been found that this object is achieved by a material for sealing off cavities between two structural components, comprising an intumescent mat, wherein the intumescent mat is completely sealed in a polymeric film and the interior bounded by the polymeric film and containing the intumescent mat is evacuated.

### BRIEF DESCRIPTION OF THE SEVERAL VIEWS OF THE DRAWING

FIG. 1A shows a schematic depiction of a preferred embodiment for an intumescent mat, prior to evacuation.

FIG. 1B shows the same intumescent mat after evacuation.

FIG. 2 shows a schematic depiction for the preferred joining of intumescent mats by rabbet.

FIG. 3 shows a schematic depiction of the inventive material formed of an intumescent mat, with cross-sectional depiction in FIG. 3A.

FIG. 4 shows a preferred embodiment of the inventive material comprising an intumescent mat and a fibrous mat of oxidic fibers, with cross-sectional depiction in FIG. 4A.

FIG. 5 shows a further preferred embodiment of the inventive material comprising an intumescent mat reinforced at the front end, with cross-sectional depiction in FIG. 5A.

FIG. 6 shows a further preferred embodiment of an inventive intumescent mat with interply for mechanical stabilization.

FIG. 7 shows a further preferred embodiment of an inventive intumescent mat with interply for mechanical stabilization.

FIG. 8 shows a further preferred embodiment of the inventive material with preferably three superposed intumescent mats, before evacuation and after evacuation in FIG. 8A.

FIG. 9 shows a schematic depiction for the preferred use of the inventive material for sealing off a catalyst bed from the inner wall of the reactor, in cross-sectional depiction through the reactor, and depiction in longitudinal section in FIG. 9A.

FIG. 10 shows a schematic depiction for a further preferred use of the inventive material for sealing off monoliths from the inner wall of the reactor, in cross-sectional depiction of the reactor, and depiction in longitudinal section in FIG. 10A.

FIG. 11 shows a schematic depiction of the preferred use of the inventive material for a ceiling duct or a chimney seal.

FIG. 12 shows a schematic depiction of a further preferred use of the inventive material for sealing off pipe connections, for example for terminals in combustion chambers.

### DETAILED DESCRIPTION OF THE INVENTION

More particularly, the two structural components are formed of materials having different thermal characteristics or of the same material but have different temperatures.

The effect of evacuating the interior containing the intumescent mat is to compress said interior, generally by above 50% compared with its original thickness, while the original length and width of the intumescent mat are unchanged. Pressing down on the evacuated intumescent mat with a finger leaves virtually no depression.

Intumescent mats are sheet-shaped bodies having a thickness of about 3 to 20 mm and preferably of about 5 to 10 mm.

Intumescent mat width and length are dictated by manufacturing requirements, each being arranged from about 0.5 to 5 m. Typical intumescent mat dimensions are 1.20 m×4 m.

Intumescent mats are generally composed of silicates, especially in the form of fibers, e.g., aluminum silicate, an expandable mica, i.e., a material which expands in the event of temperature elevation, e.g., the nontoxic vermiculite, and an organic binder. INTERAM® intumescent mats are available from 3M for example.

However, organic binders have a whole series of disadvantageous properties in that, more particularly, they cause odor nuisance due to offgassing volatiles and also catalyst poisoning. Intumescent mats are therefore increasingly required to have a reduced level of organic binders, from formerly about 12 to 14 wt % to currently about 2 to 5 wt % and especially 3 to 4 wt % of organic binder, based on the overall weight of the intumescent mat. The reduced level of organic binder, however, makes the intumescent mats more crumbly, less plastically formable and more inconvenient to handle.

The organic binder may be comprised in an amount of from 2 to 15 wt %, based on the overall weight of the intumescent mat, but preferably from 2 to 8 wt % and more preferably from 3 to 4 wt %, in each case based on the overall weight of the intumescent mat.

In a preferred embodiment the organic binder is present in form of organic polymeric fibers, especially in the form of organic polymeric fibers with two or more melting ranges.

Intumescent mats containing silicate fibers, an expandable mica and organic polymeric fibers are especially advantageous, because they show spring properties, and accordingly they assure an excellent sealing off by fastening between the structural components, between which cavities must be bridged.

At temperature increase, as soon as the first or the only melting range is reached, the organic polymeric fibers begin to melt, and cross-link (stick together) the silicates present in form of fibers. In this way the silicate fibers form a fiber matrix with hollow spaces, wherein the expandable mica is embedded. At elevated temperature the expandable mica exerts a tension on the fiber matrix and expands the same. When the temperature falls again, the expandable mica reduces its volume, but the fiber matrix maintains the tension to the most extent.

Especially advantageous are organic polymeric fibers with two or more melting ranges: a first fraction of organic polymeric fibers, with a lower melting range, for example of about 500° C., at first forms a coarse structure by cross-linking of a part of the silicate fibers; at further temperature increase to for example about 700 to 800° C., a further fraction of organic polymeric fibers is melting and cross-links additional silicate fibers, so that additional tension is exerted. In this way the required tension between the structural components to be connected can be ensured.

Preferably the amount of the organic polymeric fibers in the intumescent mat is from 2 to 8 wt % and more preferably from 3 to 4 wt %, in each case based on the overall weight of the intumescent mat.

However, enveloping the intumescent mats completely in a polymeric film in the manner of the present invention, overcomes these disadvantages in that even mats having the required reduced binder contents are simple to handle and introduce into the cavities to fill same out.

According to the present invention, the intumescent mats are completely enveloped in a film of a plastic formed more particularly of one or more polyamides, preferably of a mixture of polyamides with polyethylene and/or polypropylene.

The mat is preferably enclosed in a polymeric film which has a textured surface, i.e., a surface which is not perfectly smooth, on one side; the mat is wrapped with the polymeric film such that the textured side thereof faces the mat. This facilitates evacuation, since the fine surficial structures on the mutually opposite textured inner surfaces of the polymeric film rest against each other to form cavities through which the air can be sucked away. Perfectly planar surfaces, by contrast, would stick to each other and make it difficult to evacuate the interior.

After the intumescent mat is enveloped in the polymeric film, the interior enclosed by the polymeric film and containing the intumescent mat is evacuated.

More particularly, the interior containing the intumescent mat and enclosed by the polymeric film is evacuated down to a pressure of not more than 60 mbar.

Devacuating causes the intumescent mat to extend to twice its thickness in the evacuated state. As a result, the structural components to be assembled can be fitted together loosely, with play, without application of force, while nonetheless ensuring that the intumescent mat which extends in the course of devacuation will fix the structural components securely in place.

The interior containing the intumescent mat is simple to devacuate by puncturing or incising the polymeric film.

Additionally or alternatively, the interior enclosed by the polymeric film and containing the intumescent mat can be devacuated by exposing the intumescent mat to an elevated temperature at which the polymeric film burns away.

Preferably, the individual evacuated intumescent mats are rowed together using a rectangular rabbet or a rectangular tongue and groove system to ensure tightness.

It is also possible to superpose two or more intumescent mats and then for this pack to be wrapped in a polymeric film and evacuated. This makes for simpler installation to fill out larger cavities.

The intumescent mats may be reinforced at the front end thereof to control abrasion thereof.

A preferred embodiment provides a multi-ply composite material comprising two or more intumescent mats with interplies between any two directly successive intumescent mats to mechanically stabilize said multi-ply composite material. Sieves or perforated sheets are more particularly used as interplies.

Interplies have a thickness between 0.3 and 1 mm in particular.

Interplies more particularly have an aperture ratio of about 25 to 50%.

Interplies are preferably fabricated in aluminum or stainless steel.

Interplies are preferably constructed of formable material, especially metal, in order that different desired shapes may be produced in a stable manner by forming the interplies.

The multi-ply composite material comprising two or more intumescent mats having interplies between any two successive intumescent mats is completely enclosed in a polymeric film and evacuated similarly to the individual intumescent mat.

The multi-ply composite material is particularly useful for purposes where mechanical stability of the material is comparatively important, for example for sealing off parallelepipedic structural components in cylindrical reactors.

Its use is also particularly advantageous in areas where fire protection plays an important part, for example chimney seals or seals for lines entering and exiting combustion chambers, especially large internal combustion engines or in flue cleaners.

The sealing material of the present invention provides a simple way to connect pipes to some other structural component, for example to walls or ceilings in buildings, or else structural components of combustion chambers, especially internal combustion engines. The structural components to be connected together are merely push-fitted together and the cavities in between are filled out with sealing material of the present invention. In the event of temperature elevation, for example due to a fire, the polymeric film melts, the material enclosed therein extends and in the process ensures a reliable seal. This ensures an active form of fire protection. The structural components need not be welded together.

Subject-matter of the invention is likewise the use of the afore-described material in a cylindric reactor for the production of nitric acid through catalytic combustion of ammonia on a platinum gauze, which bears on a catalyst bed for the depletion of nitrous oxide from the reaction gas mixture, wherein the catalyst bed is positioned in a catalyst cage which is arranged concentrically inside the reactor while keeping an annular gap, and wherein the material for sealing the annular gap is arranged between the catalyst cage and the outer boundary of the annular gap.

The outer boundary of the annular gap may be a metallic apron.

In another embodiment, the outer boundary of the annular gap is the inside wall of the reactor.

As the annular gap between the catalyst cage and the outer boundary thereof, in particular in case of the metallic apron or the inside wall of the reactor, often has a varying width, which is generally in the range of from 15 to 50 mm, it is preferred in order to fill the annular gap to place multiple intumescent mats on top of each other, with or without mismatch.

It is furthermore preferred to employ intumescent mats of varying thickness, in particular it is possible to initially insert non-vacuumed intumescent mats and afterwards insert vacuumed intumescent mats into the annular gap.

By the installation of intumescent mats, it was possible to reduce the emissions of climate-damaging nitrous oxide in a reactor for the industrial production of nitric acid, which had a capacity of 100000 tons per year, by 30%.

Further subject-matter of the invention is the use of the afore-described material for the thermal insulation of the outside wall of a tube inside which a burner is arranged, wherein the material is preferably applied to the outside wall of an auxiliary tube which has a smaller diameter than the tube to be isolated, which is inserted into the tube to be isolated.

Further subject-matter of the invention is the use of the afore-described material in a hurdling contact reactor for the oxidation of sulfur dioxide to sulfur trioxide on a catalyst which contains vanadium pentoxide and which is placed in two, three, four or more hurdlings arranged on top of each other with an interstage cooling between two successive hurdlings, wherein the material is employed for sealing the gap between the outer boundary of the hurdlings and the inner wall of the hurdling contact reactor.

The oxidation of sulfur dioxide to sulfur trioxide is an essential intermediate step in the production of sulfuric acid; nowadays, exclusively the contact process is employed to this end, wherein vanadium pentoxide is employed as oxygen transferring catalyst. By the sealing of the hurdlings which carry the catalyst, against the inner wall of the reactor, according to the invention, a bypassing of the sulfur dioxide is prevented so that a higher yield is achieved.

### LIST OF REFERENCE NUMERALS

1 Intumescent mat
2 Fibrous mat
3 Interplies
4 Reinforcing material at front end
5 Inner wall of reactor
6 Catalyst cage
7 Support grid
8 Catalyst bed
9 Monoliths
10 Supported sieve
11 Interply
12 Ceiling
13 Pipe

The invention will now be more particularly described with reference to a drawing, where specifically:

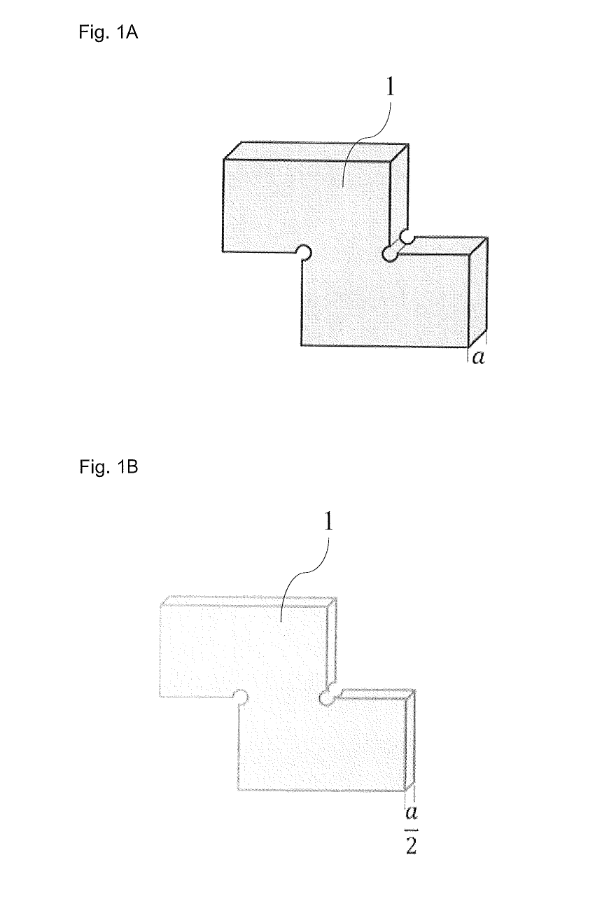

FIG. 1 shows a schematic depiction of a preferred embodiment for an intumescent mat, prior to evacuation,

FIG. 1B shows the same intumescent mat after evacuation,

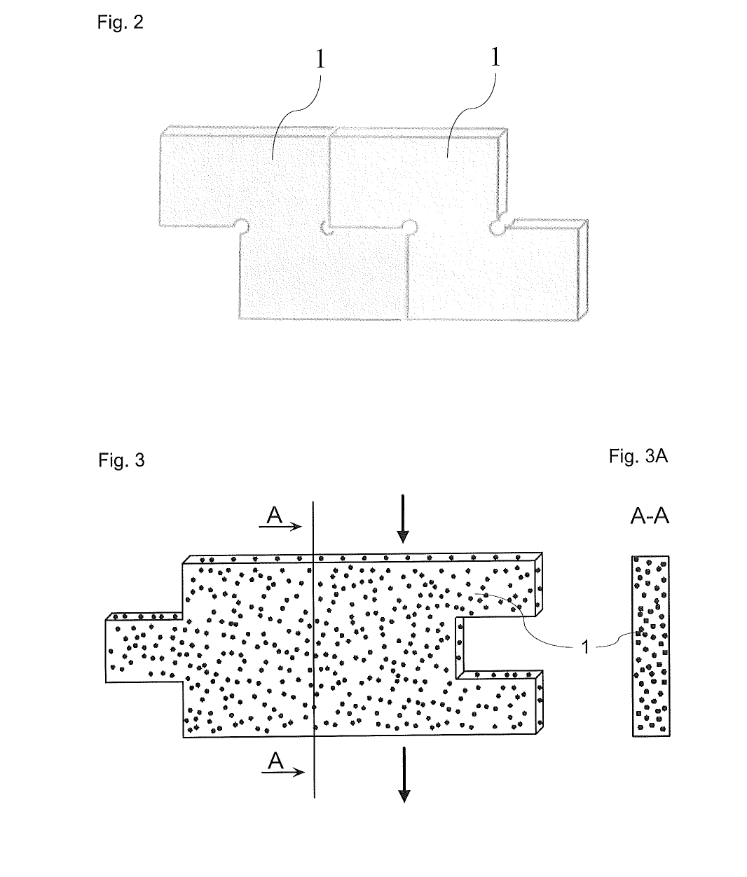

FIG. 2 shows a schematic depiction for the preferred joining of intumescent mats by rabbet,

FIG. 3 shows a schematic depiction of the inventive material formed of an intumescent mat, with cross-sectional depiction in FIG. 3A,

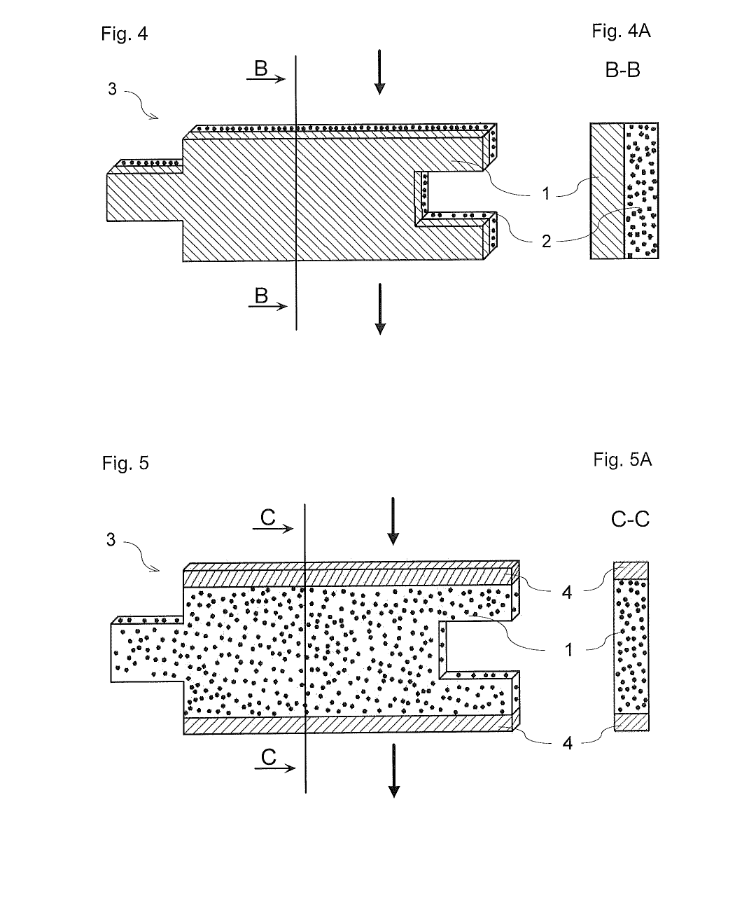

FIG. 4 shows a preferred embodiment of the inventive material comprising an intumescent mat and a fibrous mat of oxidic fibers, with cross-sectional depiction in FIG. 4A,

FIG. 5 shows a further preferred embodiment of the inventive material comprising an intumescent mat reinforced at the front end, with cross-sectional depiction in FIG. 5A,

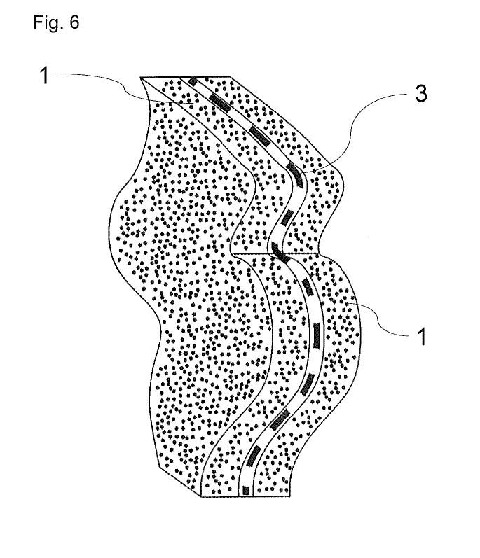

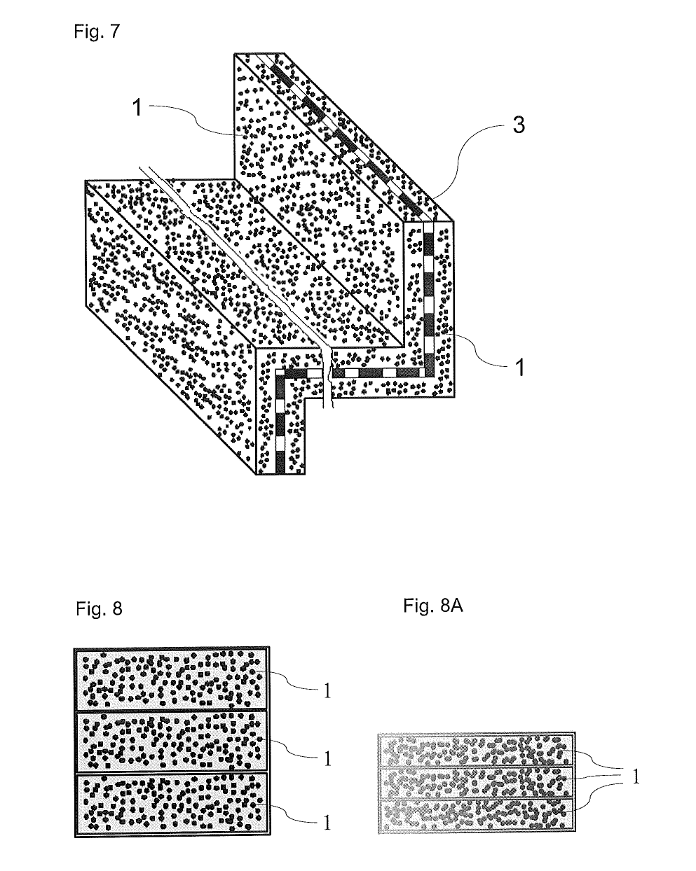

FIG. 6 and FIG. 7 show further preferred embodiments of an inventive intumescent mat with interply for mechanical stabilization,

FIG. 8 shows a further preferred embodiment of the inventive material with preferably three superposed intumescent mats, before evacuation and after evacuation in FIG. 8A,

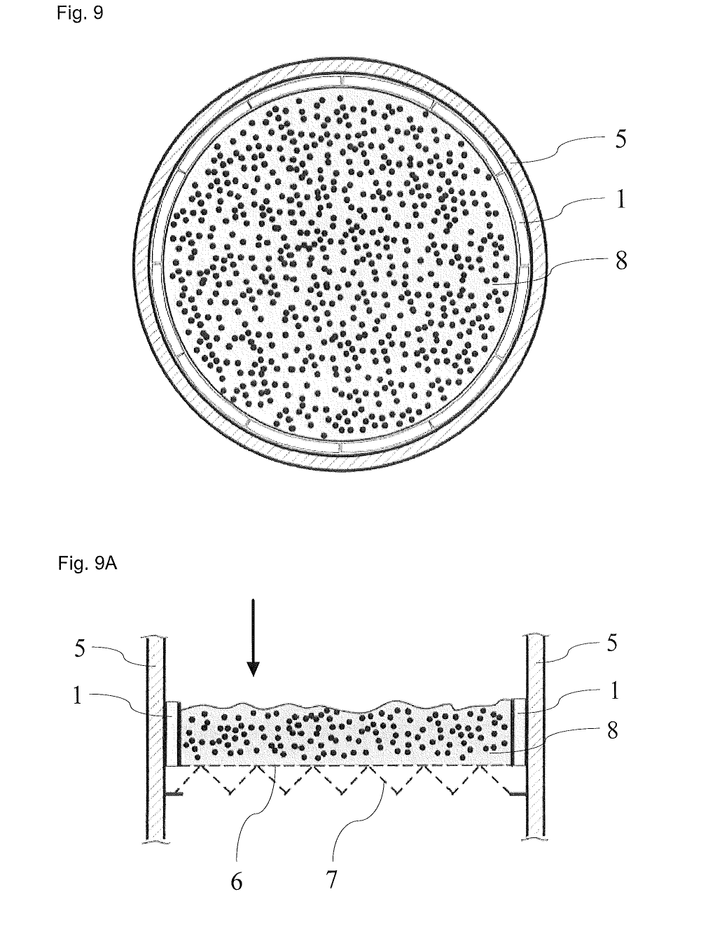

FIG. 9 shows a schematic depiction for the preferred use of the inventive material for sealing off a catalyst bed from the inner wall of the reactor, in cross-sectional depiction through the reactor, and depiction in longitudinal section in FIG. 9A,

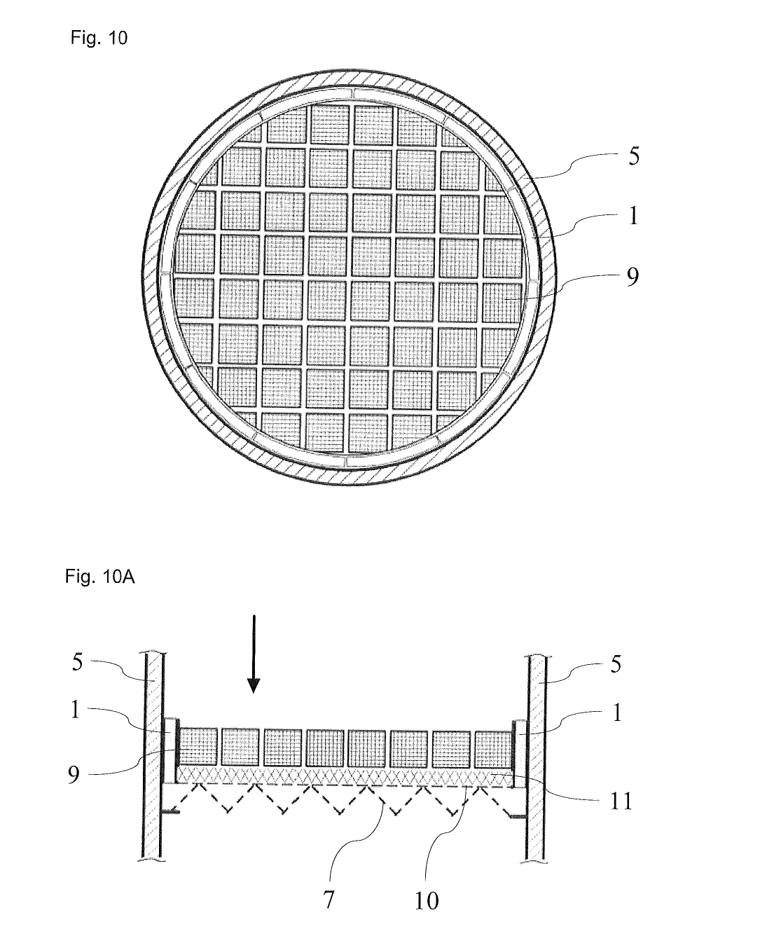

FIG. 10 shows a schematic depiction for a further preferred use of the inventive material for sealing off monoliths from the inner wall of the reactor, in cross-sectional depiction of the reactor, and depiction in longitudinal section in FIG. 10A,

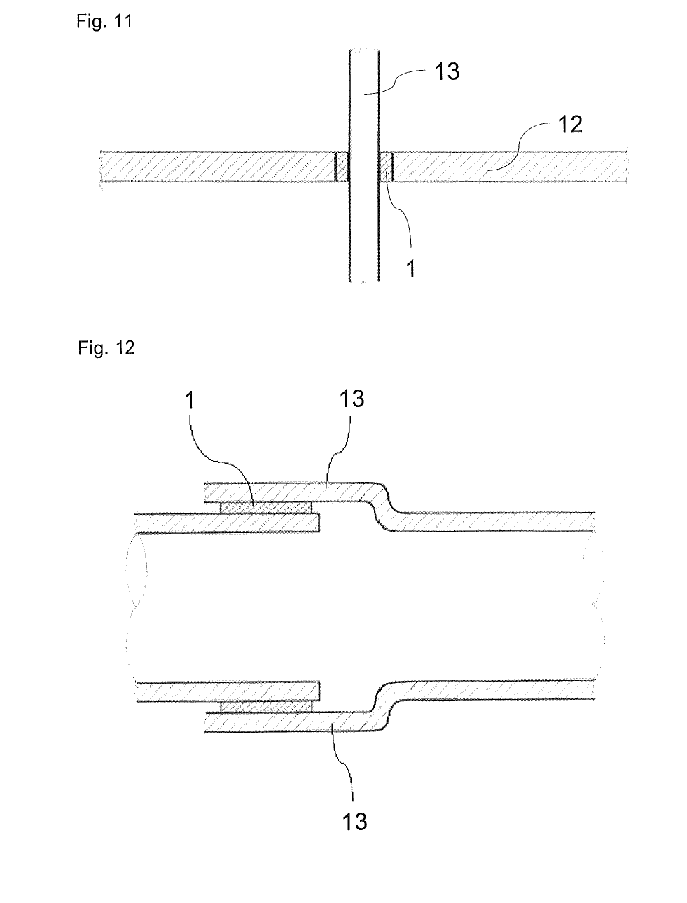

FIG. 11 shows a schematic depiction of the preferred use of the inventive material for a ceiling duct or a chimney seal, and

FIG. 12 shows a schematic depiction of a further preferred use of the inventive material for sealing off pipe connections, for example for terminals in combustion chambers.

FIG. 1A shows schematically a preferred embodiment for an intumescent mat 1, in the form of a right-angled stepdown, of thickness a, prior to being wrapped with a polymeric film.

FIG. 1B depicts the same intumescent mat 1, but after wrapping with an undepicted polymeric film and evacuating the interior whereby the thickness of the intumescent mat is reduced to a/2.

FIG. 2 shows a preferred embodiment regarding assembly of two intumescent mats 1, each in the form of a right-angled stepdown, using a right-angled rabbet to ensure tightness of the assembly.

The schematic depiction in FIG. 3 shows by way of example the inventive material consisting of an intumescent mat 1 in the form of a sheetlike ply, with cross-sectional depiction in the plane A-A in FIG. 1A.

FIG. 4 shows a further preferred embodiment for the inventive material formed of an intumescent mat 1 and a fibrous mat 2 of oxidic fibers, the mats being joined together with their major surfaces, with cross-sectional depiction in the plane B-B in FIG. 2A.

FIG. 5 shows schematically a preferred embodiment for the inventive material formed of an intumescent mat 1, with reinforcing material 4, at the front end thereof, with cross-sectional depiction in FIG. 5A.

FIGS. 6 and 7 show further preferred embodiments for the inventive material, as composite material comprising an interply 3 between two successive intumescent mats 1 for the purpose of providing mechanical stabilization to the multi-ply composite material.

FIG. 8 shows a preferred embodiment wherein, by way of example, three intumescent mats 1 are in a mutually superposed arrangement, prior to being wrapped with a polymeric film and the interior being evacuated, and, respectively, after wrapping with an undepicted polymeric film and evacuating of the interior in FIG. 8A.

FIG. 9 shows a schematic depiction of a preferred use of the inventive material 1 for sealing off a catalyst bed 8, from the inner wall 5 of a reactor, in cross-sectional depiction through the reactor, with depiction in longitudinal section in FIG. 9A, said FIG. 9A additionally showing the catalyst cage 6 which contains the catalyst bed and also the support grid 7 therefor.

FIG. 10 shows a schematic depiction for a further preferred use of the inventive material 1, for sealing off monoliths 9, from the inner wall 5 of a reactor, in cross-sectional depiction through the reactor, with depiction in longitudinal section in FIG. 10A, said FIG. 10A additionally showing the support grid 7, the supported sieve 10 and also an interply 11, wherein said interply 11 is formed of a material having openings which are dimensioned such that the downward gas flow through the reactor, indicated by an arrow in FIG. 10A, can exit through the channels in the monoliths and same are not occluded by the supported sieve 10.

FIG. 11 shows a schematic depiction for a preferred use of the inventive material comprising an intumescent mat 1, for sealing off a duct through a schematically indicated ceiling 12 for a metallic pipe 13.

FIG. 12 shows schematically a further preferred use for pipe connections, between pipes 13 which are exposed to elevated temperatures.

1-20. (canceled)

21. A material for sealing off cavities between two structural components, comprising an intumescent mat, wherein the intumescent mat is completely sealed in a polymeric film and the interior bounded by the polymeric film and containing the intumescent mat is evacuated.

22. The material of claim 21 wherein the two structural components are formed of materials having different thermal characteristics or of the same material but have different temperatures.

23. The material of claim 21 wherein said intumescent mat comprises an expandable mica, a silicate and an organic binder.

24. The material of claim 23 wherein the intumescent mat comprises the organic binder in an amount of from 2 to 15 wt %, based on the overall weight of the intumescent mat.

25. The material of claim 23 wherein the silicate is an aluminum silicate.

26. The material of claim 23 wherein the expandable mica is vermiculite.

27. The material of claim 21 consisting of an intumescent mat.

28. The material of claim 21 being a composite mat, said composite mat in addition to an intumescent mat comprising a fibrous mat of oxidic fibers, wherein said intumescent mat and said fibrous mat of oxidic fibers are each sheet bodies joined together at their major surfaces.

29. The material of claim 28 wherein the composite mat comprises a plurality of successive plies of one intumescent mat and one fibrous mat of oxidic fibers.

30. The material of claim 21 formed as a multi-ply composite material comprising two or more intumescent mats with interplies between any two directly successive intumescent mats to mechanically stabilize said multi-ply composite material.

31. The material of claim 30 wherein said interplies are formed of sieves or perforated sheets.

32. The material of claim 21 wherein plastics used for the polymeric film comprise one or more polyamides or mixtures of one or more polyamides with polyethylene and/or polypropylene.

33. The material of claim 21 wherein the polymeric film is textured on one side thereof.

34. A method of sealing off cavities between two structural components by using a material of claim 21, which method comprises devacuating the material after insulation in the cavity between the structural components.

35. The method of claim 34 wherein the material is devacuated by puncturing or incising the polymeric film or by elevating the temperature to a value at which the polymeric film burns away.

36. A process for the production of nitric acid, said process comprising catalytic combustion of ammonia on a platinum gauze, which bears on a catalyst bed for the depletion of nitrous oxide from the reaction gas mixture, wherein the catalyst bed is positioned in a catalyst cage which is arranged concentrically inside a reactor comprising the material of claim 21 while keeping an annular gap, and wherein the material for sealing the annular gap is arranged between the catalyst cage and the outer boundary of the annular gap.

37. The process of claim 36, wherein the outer boundary of the annular gap is a metallic apron.

38. The process of claim 36, wherein the outer boundary of the annular gap is the inside wall of the reactor.

39. A process for the thermal insulation of the outside wall of a tube inside which a burner is arranged, wherein the material of claim 21 is applied to the outside wall of an auxiliary tube which has a smaller diameter than the tube to be isolated, which is inserted into the tube to be isolated.

40. A process for the production of sulfur trioxide, said process comprising oxidation of sulfur dioxide in a hurdling contact reactor on a catalyst which contains vanadium pentoxide and which is placed in two, three, four or more hurdlings arranged on top of each other with an interstage cooling between two successive hurdlings, wherein the material of claim 21 is employed for sealing the gap between the outer boundary of the hurdlings and the inner wall of the hurdling contact reactor.
